(19) United States
(12) Patent Application Publication
(10) Pub. No.: US 2005/0016813 A1
(43) Pub. Date: Jan. 27, 2005

(54) Wet-type multiplate clutch

(75) Inventors: Takayuki Watanabe, Shimada-shi (JP); Masahiri Kobayashi, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-WARNER K.K.

(21) Appl. No.: 10/780,763

(22) Filed: Feb. 19, 2004

(30) Foreign Application Priority Data
Feb. 20, 2003 (JP) 2003-042209

(51) Int. Cl. F16D 13/72

(52) U.S. Cl. 192/70.12; 192/70.14; 192/85 AA; 192/113.36

(57) ABSTRACT

Provided is a wet-type multiplate clutch including: a rotary outer member and a stationary inner member; a first frictional engagement element provided to the outer member and a second frictional element provided to the inner member, the first frictional engagement element and the second frictional engagement element being alternately and coaxially arranged; and a piston for axially pressing the first frictional engagement element and the second frictional engagement element into frictional engagement with each other, the wet-type multiplate clutch being characterized in that the first frictional engagement element is provided with oil grooves that are inclined against a rotational direction of the first frictional engagement element.

### BACKGROUND OF THE INVENTION

1. Field of the Invention

The present invention relates to a wet-type multiplate clutch used in an automatic transmission of a vehicle, construction/agricultural machinery, or the like.

2. Related Background Art

FIGS. 5 and 6 show frictional engagement elements used in a conventional wet-type multiplate clutch. FIG. 5 is a front view of a friction plate, and FIG. 6 is a front view of a separator plate.

As shown in FIG. 5, a friction plate 30 to be arranged in a not-shown inner member is formed by fixing plural friction material segments 32 in an annular fashion onto a core plate having splines 34 provided on its inner periphery. First oil grooves 31 and second oil grooves 33 are formed by fixing the friction material segments 32 at predetermined intervals.

Further, as shown in FIG. 6, a separator plate 20 to be arranged in a not-shown outer member is provided with plural claws 21 on its outer periphery and supported onto the outer member. In this case, typically, both the inner member and the outer member are rotary members, or the inner member is a rotary member and the outer member is a stationary member, thus making it possible to perform efficient supply of lubricating oil.

Examples of such a wet-type multiplate clutch include those proposed in the following documents. Japanese Patent Application Laid-open No. 11-82537 discloses a structure in which lubricating oil is captured by a wall provided in a rotary pressure plate serving as an inner member.

Similarly to Japanese Patent Application Laid-open No. 11-82537, Japanese Patent Application Laid-open No. 2000-35056 also discloses a structure in which lubricating oil is captured by a wall provided in a rotary pressure plate serving as an inner member.

Japanese Patent Application Laid-open No. 2001-221252 discloses a structure in which oil grooves are formed in a friction plate so as to be inclined with respect to the circumferential direction of the rotary friction plate serving as an inner member.

Japanese Patent Application Laid-open No. 10-169681 discloses a friction plate having oil grooves formed in a rotational direction of the friction plate.

Since the inner member is rotatable according to the structures disclosed in the four documents mentioned above, the problem to be solved by the invention does not arise. However, in the case where the inner member is a stationary member, the lubricating oil simply drops downward as it is pulled by the force of gravity, making it difficult to supply the lubricating oil to the entire friction surface.

### SUMMARY OF THE INVENTION

In view of the above problem, an object of the present invention is to provide a wet-type multiplate clutch which enables efficient supply of lubricating oil in the case where an inner member is a stationary member.

In order to attain the above object, a wet-type multiplate clutch according to the present invention includes: a rotary outer member and a stationary inner member; a first frictional engagement element provided to the outer member and a second frictional element provided to the inner member, the first frictional engagement element and the second frictional engagement element being alternately and coaxially arranged; and a piston for axially pressing the first frictional engagement element and the second frictional engagement element into frictional engagement with each other, the wet-type multiplate clutch being characterized in that the first frictional engagement element is provided with oil grooves that are inclined against a rotational direction of the first frictional engagement element.

The first frictional engagement element has the oil grooves that are inclined against the rotational direction of the first frictional engagement element, whereby the supply of lubricating oil can be performed efficiently in a case where the inner member is a stationary member.

Note that the expression “inclined against a rotational direction” as used herein means that the corresponding angle defined with respect to the rotational direction of the frictional engagement member is an acute angle.

### BRIEF DESCRIPTION OF THE DRAWINGS

FIG. 1 is an axial cross-sectional view of a wet-type multiplate clutch according to an embodiment of the present invention;

FIG. 2 is an enlarged axial cross-sectional view showing frictional engagement elements of FIG. 1 in detail;

FIG. 3 is a front view of a separator plate used in the embodiment of the present invention;

FIG. 4 is a front view of a friction plate used in the embodiment of the present invention;

FIG. 5 is a front view of a friction plate used in a conventional wet-type multiplate clutch; and

FIG. 6 is a front view of a separator plate used in the conventional wet-type multiplate clutch.

### DESCRIPTION OF THE PREFERRED EMBODIMENTS

Hereinbelow, an embodiment of the present invention is described in detail with reference to the accompanying drawings. Note that, in the drawings, identical parts are denoted by the same symbols.

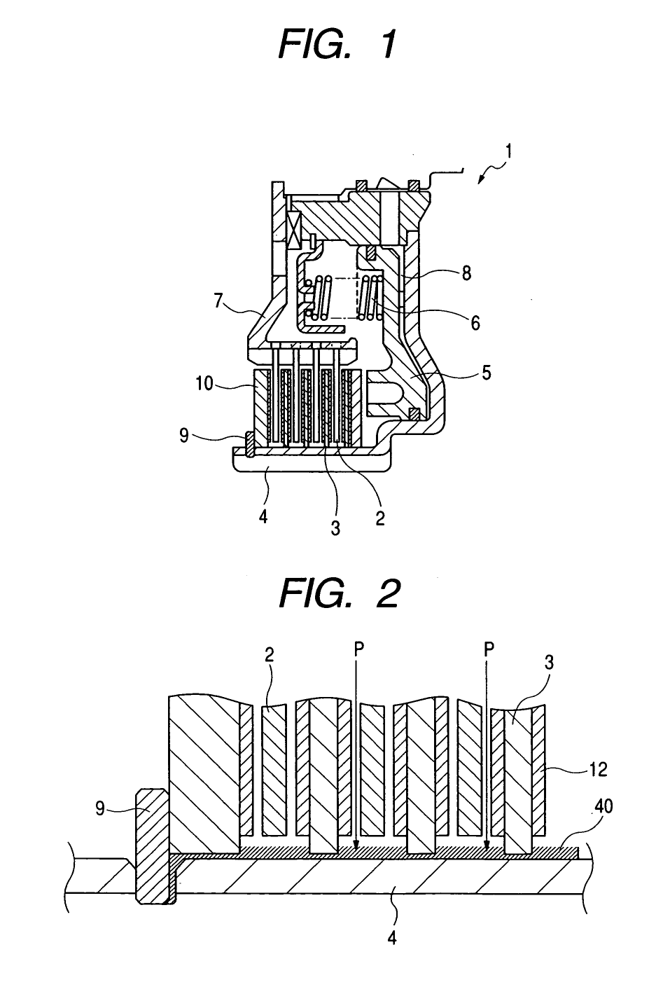

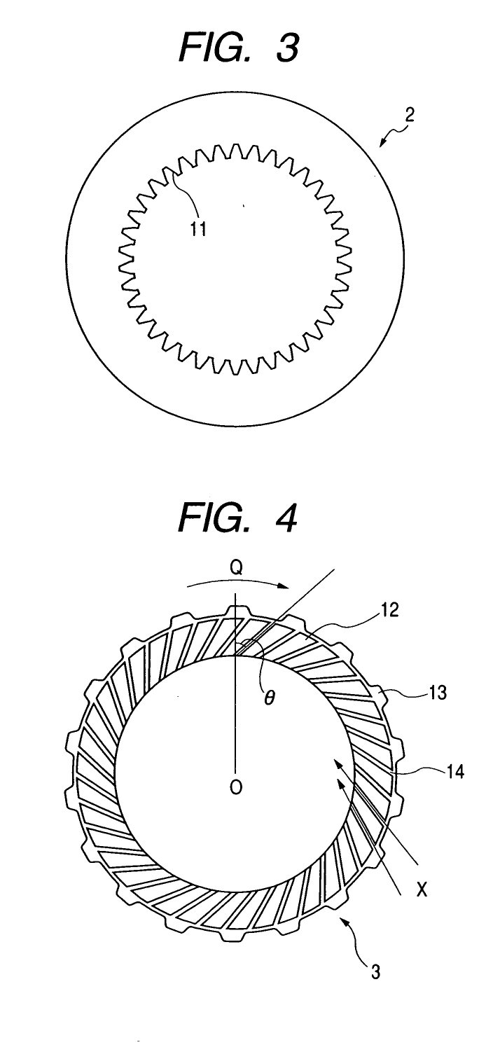

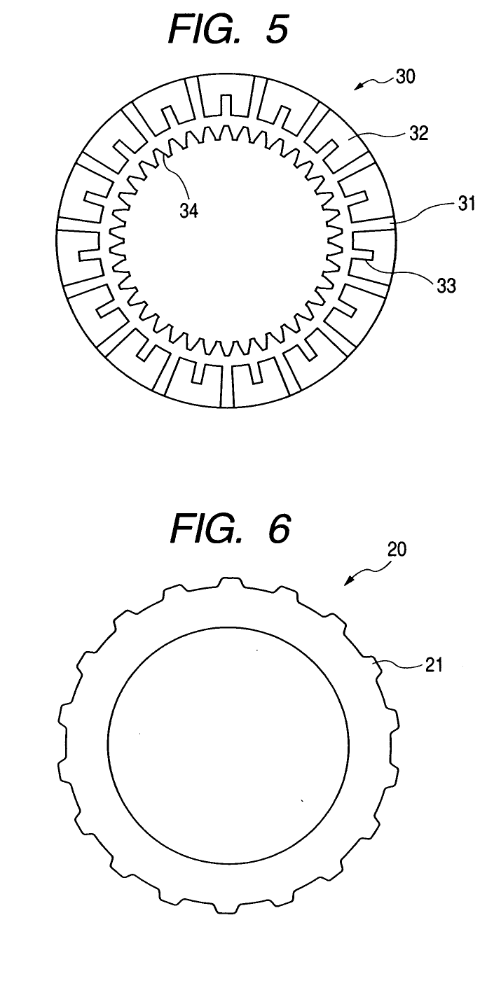

FIG. 1 is an axial cross-sectional view of a wet-type multiplate clutch according to an embodiment of the present invention. FIG. 2 is an enlarged axial cross-sectional view showing frictional engagement elements of FIG. 1 in detail. A wet-type multiplate clutch 1 includes: a substantially annular first friction engagement element, namely a frictional plate 3 having on its outer periphery plural teeth 13 (see FIG. 4) that fittingly engage spline grooves provided on an inner periphery of a clutch case 4; and a substantially annular second friction engagement element, namely a separator plate 2 arranged inside the clutch case 4 and having on its inner periphery plural teeth 11 (see FIG. 3) that fittingly engage spline grooves provided in an outer periphery of a hub 7 rotating relative to the clutch case 4. The separator plate 2 and the friction plate 3 are axially movable along the spline grooves.

The clutch case 4 of the wet-type multiplate clutch 1 further includes a piston 5. An oil chamber 8 is defined between the piston 5 and an inner surface of the clutch case 4. The piston 5 is urged by a return spring 6 so as to release the engagement between the frictional engagement elements.

Provided in an axial end portion of the clutch case 4 is a support member 10 for regulating axial movements of the separator plate 2 and the friction plate 3, and for sandwiching the separator plate 2 and the friction plate 3 between the support member 10 and the piston 5 at the time when a pressing force of the piston 5 is applied. The support member 10 is fixed in position with its axial movement restricted by a retaining ring 9.

The wet-type multiplate clutch 1 constructed as described above operates as follows. When an oil pressure is supplied to the oil chamber 8, the piston 5 moves in the leftward direction in the figure against the urging force of the return spring 6, thereby applying a pressing force to the separator plate 2 and the friction plate 3 for engagement therebetween. Accordingly, the separator plate 2 and the friction plate 3 are fastened to each other between the piston 5 and the support member 10, thus effecting transmission of power.

When the oil pressure is removed, the piston 5 moves in the rightward direction in the figure by the urging force of the return spring 6, thereby releasing the fastening between the separator plate 2 and the friction plate 3. In other words, the clutch is released.

Next, a flow of lubricating oil is described with reference to FIG. 2. A lubricating oil 40 having lubricated the frictional engagement surface between the separator plate 2 and the friction plate 3, and the like moves downward as indicated by arrow P due to its own weight, to build up in a bottom portion of the clutch case 4. An outer peripheral rim of the rotating friction plate 3 penetrates into a layer of the lubricating oil 40 that has built up in the bottom portion of the clutch case 4.

As shown in FIG. 2, when the clutch case 4 as an outer member is not rotating, the lubricating oil 40 drops to a lower portion as it is pulled by the force of gravity to build up therein. In this case, the rotation of the friction plate 3 having oil grooves 14 formed as shown in FIG. 4 makes it possible to draw the lubricating oil 40, which has dropped to the lower portion, toward the friction surface, thereby facilitating the supply of the lubricating oil.

Referring now to FIG. 4, the friction plate 3 is described in detail. The friction plate 3 is prepared by fixing plural friction material segments 12 onto an annular core plate with adhesives or the like. The oil grooves 14, which are formed in the friction surface to which the friction material segments 12 are fixed, penetrate the friction plate 3 in a substantially straight line from its inner periphery to its outer periphery.

When the friction plate 3 rotates in a rotational direction Q, an outer peripheral open end of each oil groove 14 penetrates into the layer of the lubricating oil having built up in the bottom portion of the clutch case 4 as shown in FIG. 2, at an acute angle with respect to the lubricating oil 40. As a result, the lubricating oil 40 passes through the oil grooves 14 in the direction of arrow X to enter the inner periphery of the friction plate 3. Accordingly, the lubricating oil 40 lubricates the friction surface between the friction plate 3 and the separator plate 2 as it passes through the oil grooves 14, and then the lubricating oil 40 that flows backward after returning from the inner periphery side lubricates the friction surface again. As a result, it is possible to facilitate the supply of the lubricating oil as required for sufficient lubrication of the friction surface.

The oil grooves 14 formed in the friction plate 3 are each formed so as to be inclined at an angle θ with respect to its radius. The oil grooves 14 are inclined against the rotational direction Q. That is, the corresponding angle θ formed with respect to the rotational direction Q of the friction plate 3 becomes an acute angle.

Further, while each oil groove 14 is formed in a substantially straight line in this embodiment, it may be formed in a curved configuration insofar as the angle θ is maintained. In addition, while the oil grooves 14 are provided in the form of gaps formed between the friction material segments 12, they may be formed by plastic processing after fixing of an annular friction material. Needless to say, the number of the plural friction material segments 12 to be fixed onto the friction plate 3 may be different from that shown in the figures.

While in FIG. 2 the friction material segments 12 are bonded to both surfaces in the axial direction of the friction plate 3, the friction material segments 12 may be bonded to only one surface thereof.

The present invention as described above has the following advantages.

That is, the oil grooves are provided to the first frictional engagement element so as to be inclined against the rotational direction of the first frictional engagement element, whereby the lubricating oil that has once dropped to the lower portion can be drawn toward the friction surface as the first frictional engagement element rotates, thereby facilitating the supply of the lubricating oil.

1. A wet-type multiplate clutch comprising:
a rotary outer member and a stationary inner member;
a first frictional engagement element provided to the outer member and a second frictional element provided to the inner member, the first frictional engagement element and the second frictional engagement element being alternately and coaxially arranged; and
a piston for axially pressing the first frictional engagement element and the second frictional engagement element into frictional engagement with each other,
wherein the first frictional engagement element is provided with oil grooves that are inclined against a rotational direction of the first frictional engagement element.

2. A wet-type multiplate clutch according to claim 1, wherein the first frictional engagement element is a friction plate to which a friction material is secured.

3. A wet-type multiplate clutch according to claim 2, wherein the friction material is secured to the friction plate in a state in which plural friction material segments are arranged circumferentially with gaps therebetween, the gaps forming the oil grooves.
